(19) United States
(12) Patent Application Publication
(10) Pub. No.: US 2018/0007352 A1
(43) Pub. Date: Jan. 4, 2018

(54) METHOD AND APPARATUS FOR ROTATION AND SWITCHING OF VIDEO CONTENT

(71) Applicant: Nokia Technologies Oy, Espoo (FI)

(72) Inventors: Hoseok Chang, Sunnyvale, CA (US); Per-Ola Robertsson, Sunnyvale, CA (US); Basavaraja Vandrotti, San Jose, CA (US); Devon Copley, Sunnyvale, CA (US); Maneli Noorkami, Sunnyvale, CA (US); Hui Zhou, Sunnyvale, CA (US)

(21) Appl. No.: 15/637,140

(22) Filed: Jun. 29, 2017

Related U.S. Application Data
(60) Provisional application No. 62/357,202, filed on Jun. 30, 2016.

(51) Int. Cl. H04N 13/04

(52) U.S. Cl. CPC H04N 13/0497; H04N 13/0445; H04N 13/0479

(57) ABSTRACT

A method, apparatus and computer program product are provided to define the location of a center point associated with each frame within a stream of image data. Metadata associated with the orientation, such as the pitch and yaw, of a camera is synchronized on a frame-by-frame basis with a related stream of image data. In connection with receiving the image data and the orientation data, the method defines a center point associated with a video frame images and transmits a control signal causing the reorientation of at least a subset of video image frames. In some example implementations, arising in the context of 360° video streams, the rotation of the head of a viewer of virtual reality content or other 360° video streams may be taken into account when defining the location of a center point.

### CROSS-REFERENCE TO RELATED APPLICATIONS

The present application claims the benefit of U.S. Provisional Patent Application Ser. No. 62/357,202 which was filed on Jun. 30, 2016 and titled METHOD AND APPARATUS FOR ROTATION AND SWITCHING OF VIDEO CONTENT, the entire content of which is incorporated by reference herein for all purposes.

### TECHNICAL FIELD

An example embodiment relates generally to image processing, particularly in the context of managing switching across multiple panoramic video feeds.

### BACKGROUND

“Live-Action” virtual reality is an increasingly popular way for individuals to experience and enjoy a variety of content, such as concerts, sporting events, and other events that the individual may not be able to readily attend in person. In some implementations of live-action virtual reality, content is provided to a viewer by switching between multiple spherical video feeds. Switching between feeds is typically accomplished via a crossfade or other type of video effects such as fade, swipe, etc. across several video frames. This rudimentary approach exhibits several drawbacks, including potential degradations to the viewing experience that occur when, at the moment the crossfade occurs, the user has oriented their display away from the most salient information in the new image sequence. This can result in confusion by the user and otherwise degrade the viewing experience by forcing the user to look around in an effort to ascertain or discover the content the user is meant to see and focus on after the crossfade.

In addition, the orientation of cameras used to capture spherical video is often fixed, however the most relevant point of interest around the camera will often change, and indeed can move rapidly, especially in sports applications. This compounds the problem of making sure the user's attention is drawn to the best direction after a crossfade.

The issues associated with conventional approaches to camera switching can be partially addressed for pre-rendered content, where individual clips may be rotated using post-production tools. However, this approach is both destructive, in the sense that it forces an orientation at the time of production rather than at the time of rendering, and impractical for live events.

### BRIEF SUMMARY

A method, apparatus and computer program product are therefore provided in accordance with an example embodiment in order to rotate and switch spherical video content, such as for use in conjunction with a virtual reality system. In this regard, the method, apparatus and computer program product of an example embodiment provide for the use of orientation data synchronized to related image data to permit the rotation of video streams in an efficient, non-destructive manner.

In an example embodiment, a method is provided that includes receiving image data, wherein the image data comprises a plurality of video image frames. The method of this example embodiment also includes receiving orientation data, wherein the orientation data is synchronized with the image data and comprises a set of pitch and yaw information for each video image frame, or a group of image frames, within the plurality of video image frames. The method of this example embodiment also includes defining the location of a center point associated with each video image frame within the plurality of video image frames. The method of this example embodiment also includes determining whether to cause a control signal to be transmitted causing a reorientation of at least a subset of the plurality of video image frames, wherein the control signal is associated with the orientation data and the location of the center point.

In some implementations of the method of an example embodiment, the video image frames within the plurality of video image frames are 360 degree video image frames. In some such implementations of the method of an example embodiment, the pitch and yaw information for each video image frame within the plurality of video image frames is associated with an orientation of a camera.

In some implementations of the method of an example embodiment, determining whether to cause a control signal to be transmitted causing a reorientation of at least a subset of the plurality of video image frames comprises causing a control signal associated with the center point to be transmitted to a plurality of camera processing systems.

In some implementations of the method of an example embodiment, defining the location of a center point associated with each video image frame within the plurality of video image frames comprises receiving a set of head rotation data, wherein the set of head rotation data is associated with an orientation of the head of a viewer of the image data. Some such implementations of the method of an example embodiment comprise receiving a set of point-of-interest position information, wherein the set of point-of-interest position information comprises an indication of the location of a point-of-interest within a video image frame. This point-of-interest position information may be expressed either relative to the camera's location, or in an absolute coordinate matrix. In some such implementations of the method of an example embodiment, defining the location of a center point associated with each video image frame within the plurality of video image frames comprises calculating an offset between the orientation of the head of the viewer of the image data and the location of the point-of-interest within each video image frame.

In another example embodiment, an apparatus is provided that includes at least one processor and at least one memory that includes computer program code with the at least one memory and the computer program code configured to, with the at least one processor, cause the apparatus to at least receive image data, wherein the image data comprises a plurality of video image frames; receive orientation data, wherein the stream of orientation data is synchronized with the image data and comprises a set of pitch and yaw information for each video image frame, or a set of video image frames, within the plurality of video image frames; define the location of a center point associated with each video image frame within the plurality of video image frames; and determine whether to cause a control signal to be transmitted causing a reorientation of at least a subset of the plurality of video image frames, wherein the control signal is associated with the orientation data and the location of the center point.

In some implementations of the apparatus of an example embodiment, the video image frames within the plurality of video image frames are 360 degree video image frames. In some such implementations, the pitch and yaw information for each video image frame within the plurality of video image frames is associated with an orientation of a camera.

In some implementations of the apparatus of an example embodiment, the at least one memory and the computer program code are configured to, with the processor, further cause the apparatus to determine to cause the control signal to be transmitted causing the reorientation of at least a subset of the plurality of video image frames by causing the apparatus to cause a control signal associated with the center point to be transmitted to a plurality of cameras.

In some implementations of the apparatus of an example embodiment, the at least one memory and the computer program code are configured to, with the processor, further cause the apparatus to define the location of the center point associated with each video image frame within the plurality of video image frames by causing the apparatus to receive a set of head rotation data, wherein the set of head rotation data is associated with an orientation of the head of a viewer of the image data. In some such implementations, the at least one memory and the computer program code are configured to, with the processor, further cause the apparatus to receive a set of point-of-interest position information, wherein the set of point-of-interest position information comprises an indication of the location of a point-of-interest within a video image frame. In some such further implementations, the at least one memory and the computer program code are configured to, with the processor, cause the apparatus to define the location of the center point associated with each video image frame within the plurality of video image frames by causing the apparatus to calculate an offset between the orientation of the head of the viewer of the image data and the location of the point-of-interest within each video image frame.

In a further example embodiment, a computer program product is provided that includes at least one non-transitory computer-readable storage medium having computer-executable program code instructions stored therein with the computer-executable program code instructions including program code instructions configured to receive image data, wherein the image data comprises a plurality of video image frames; receive orientation data, wherein the orientation data is synchronized with the image data and comprises a set of pitch and yaw information for each video image frame within the plurality of video image frames; define the location of a center point associated with each video image frame within the plurality of video image frames; and determining whether to cause a control signal to be transmitted causing a reorientation of at least a subset of the plurality of video image frames, wherein the control signal is associated with the orientation data and the location of the center point.

In an implementation of the computer-executable program code instructions of an example embodiment, the video image frames within the plurality of video image frames are 360 degree video image frames. In some such implementations of the computer-executable program code instructions of an example embodiment, the pitch and yaw information for each video image frame within the plurality of video image frames is associated with an orientation of a camera.

In an implementation of the computer-executable program code instructions of an example embodiment, the computer-executable program code instructions further comprise program code instructions configured to determine whether to cause the control signal to be transmitted causing the reorientation of at least a subset of the plurality of video image frames by causing a control signal associated with the center point to be transmitted to a plurality of cameras.

In an implementation of the computer-executable program code instructions of an example embodiment, the computer-executable program code instructions further comprise program code instructions configured to define the location of the center point associated with each video image frame within the plurality of video image frames by receiving a set of head rotation data, wherein the set of head rotation data is associated with an orientation of the head of a viewer of the image data. In some such implementations, the computer-executable program code instructions further comprise program code instructions configured to receive a set of point-of-interest position information, wherein the set of point-of-interest position information comprises an indication of the location of a point-of-interest within a video image frame; and define the location of the center point associated with each video image frame within the plurality of video image frames by calculating an offset between the orientation of the head of the viewer of the image data and the location of the point-of-interest within each video image frame.

In yet another example embodiment, an apparatus is provided that includes means for receiving image data, wherein the image data comprises a plurality of video image frames; receiving orientation data, wherein the orientation data is synchronized with the image data and comprises a set of pitch and yaw information for each video image frame within the plurality of video image frames; defining the location of a center point associated with each video image frame within the plurality of video image frames; and determining whether to cause a control signal to be transmitted causing a reorientation of at least a subset of the plurality of video image frames, wherein the control signal is associated with the orientation data and the location of the center point. In some implementations of the apparatus of an example embodiment, the video image frames within the plurality of video image frames are 360 degree video image frames. In some such implementations, the pitch and yaw information for each video image frame within the plurality of video image frames is associated with an orientation of a camera.

In an implementation of the apparatus of an example embodiment, the means for determining whether to cause a control signal to be transmitted causing a reorientation of at least a subset of the plurality of video image frames comprises causing a control signal associated with the center point to be transmitted to a plurality of cameras.

In an implementation of the apparatus of an example embodiment, the means for defining the location of a center point associated with each video image frame within the plurality of video image frames include means for receiving a set of head rotation data, wherein the set of head rotation data is associated with an orientation of the head of a viewer of the image data. In some such implementations, the apparatus further includes means for receiving a set of point-of-interest position information, wherein the set of point-of-interest position information comprises an indication of the location of a point-of-interest within a video image frame. In some such implementations, the means for defining the location of a center point associated with each video image frame within the plurality of video image frames include means for calculating an offset between the orientation of the head of the viewer of the image data and the location of the point-of-interest within each video image frame.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts an example system environment in which implementations in accordance with an example embodiment of the present invention may be performed;

FIG. 2 is a block diagram of an apparatus that may be specifically configured in accordance with an example embodiment of the present invention;

FIG. 3 is a flowchart illustrating a set of operations performed, such as by the apparatus of FIG. 2, in accordance with an example embodiment of the present invention; and

FIG. 4 is a flowchart illustrating another set of operations performed, such as by the apparatus of FIG. 2, in accordance with an example embodiment of the present invention.

FIG. 5 depicts an example system environment in which implementations in accordance with an example embodiment of the present invention may be performed.

FIG. 6 depicts an example system environment in which implementations in accordance with an example embodiment of the present invention may be performed.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to efficiently implement advanced approaches to the rotation and switching of 360° image content. Example implementations discussed herein contemplate at least two overall contexts in which the advanced approaches to rotation and switching of 360° image content may be practiced and be particularly advantageous. In one such overall context, rotation of 360° image content and/or switching between multiple sources of 360° image content is performed before transmission of such content to one or more viewers. For example, one or more directors, content producers, automated algorithms and/or processors may rotate and/or switch 360° image content based at least in part on metadata that is synchronized and/or otherwise associated with frames of the 360° image content. In another such overall context, rotation of 360° image content and/or switching between multiple sources of 360° image content is performed by a viewer of 360° image content and/or takes into account information received from such a viewer. For example, one or more viewers, viewing devices, and/or automated algorithms and/or processors associated with a viewing device may rotate and/or switch 360° image content based at least in part on metadata that is synchronized and/or otherwise associated with frames of the of 360° image content.

Numerous sources and/or types of metadata may be used, either singly or in combination with other sources and/or types of metadata and/or other information, in the rotation of image frames. One such type of metadata includes physical orientation information received from and/or otherwise associated with a camera. In some situations, such physical orientation information may be obtained from one or more gyroscopes integrated into and/or otherwise associated with the orientation of a camera. Another such type of metadata includes a “center” or “saliency point” associated with an image that is set by an external agent, such as by a director. In some situations, a center or saliency point set by a director may be based on the director's subjective preferences regarding the appearance and placement of content within an image. A third such type of metadata includes an automatically identified center or saliency point, including but not limited to one that may be set through the application of an automated algorithm or other protocol. A fourth type of metadata includes point-of-interest metadata. In some situations, point-of-interest metadata can be expressed as a relative position of a point-of-interest and/or as an absolute position of a point-of-interest. Regardless of the framework used to express the position of a point-of-interest, such metadata may, in some situations, be used to express the positions of multiple points-of-interest, including multiple points-of-interest that may or may not appear in a particular frame. A fifth such type of metadata includes display window rotation information. Display window information may be particularly useful in situations where a user can exert control over the rotation and/or switching of 360° content presented to the viewer. In some situations, rotation information associated with a user's viewing system, such as a headset display, handheld monitor, desktop monitor, other viewing system in used in developing display wind rotation information. Other information associated with a user, such as input information, user position information, and the like may be included with display window rotation information. While many of the examples herein reference the use of one or more types of metadata in the particular implementations described, it should be understood that all of the various types of metadata referenced and/or contemplated herein, including but not limited to any combinations thereof, may be used in implementations of the methods, apparatuses, and computer program products contemplated herein.

Example implementations discussed herein contemplate providing orientation information, such as pitch and yaw information for one or more cameras associated with a saliency point, for example, as a metadata transmission, such as a metadata stream. In some such implementations, the orientation information metadata transmission or stream may be synchronized to the related video stream. Unlike conventional approaches to 360° video imaging that are limited in the sense that they permit only a one-time setting of a reference point within a given 360° video track, the pitch and yaw information contemplated herein may be updated and/or synchronized to the related video stream on a frame-by-frame basis.

The synchronization of pitch and yaw information to a 360° video stream on a frame-by-frame basis allows for the center point of a 360° video stream to be defined, and subsequently redefined, at any time. As a result, end-users, such as viewers of content, directors, and/or other content producers can exert a level of control over the orientation of content and the viewing experience that is unavailable via conventional approaches, particularly in the context of live-action, virtual reality content.

Some example implementations discussed herein contemplate providing location information, such as absolute position information and/or relative position information for one or more cameras, saliency point(s), points-of-interest, and/or other image elements, as a metadata transmission, such as a metadata stream. Location information may be include, for example, GPS information, position information derived from an HAIP system (High Accuracy Indoor Positioning System), other coordinate information, and/or any other information associated with the location of an image element. In some such example implementations, the location information metadata transmission or stream may be updated and/or synchronized to the related video stream. Unlike conventional approaches to 360° video imaging that are limited in the sense that they permit only a one-time setting of a reference point within a given 360° video track, the information contemplated herein may be updated and/or synchronized to the related video stream on a frame-by-frame basis.

The synchronization of location information associated with a saliency point and/or one or more points-of-interest to a 360° video stream on a frame-by-frame basis allows for the center point of a 360° video stream to be defined, and subsequently redefined, at any time. As a result, end-users, such as viewers of content, directors, and/or other content producers can exert a level of control over the orientation of content and the viewing experience that is unavailable via conventional approaches, particularly in the context of live-action, virtual reality content.

Some example implementations arise in the context of an individual, such as a director or other content producer, actively defining and/or redefining the center point of a 360° sphere (as in a 360° video stream) at will. In some such example implementations, pitch and yaw information for a camera associated with a saliency point is transmitted for every frame within a 360° video stream by each camera. In contexts where a director is involved with content capture, composition, and/or creation, the director may redefine the center point of the 360° sphere associated with a camera based on the director's perception of saliency and/or other considerations, such as aesthetic preferences, changes in saliency, change in the saliency of other image elements, or the like. In some such implementations, such as those where multiple cameras are used simultaneously, a change in the center point in of one 360° sphere associated with one camera can be used to trigger changes to the center point of each respective 360° sphere associated with each respective camera.

Some example implementations of embodiments described and contemplated herein arise in the context of a user—such as a viewer of virtual reality content using a virtual reality viewing device—causing, directly or indirectly, a reorientation of the 360° sphere of content experienced by the user. In some such example implementations, orientation information, such as the pitch and yaw information, for example, is sent to the viewer's viewing device as metadata that is synchronized, on a frame-by-frame basis, with the video content displayed to the viewer. Such example implementations may be particularly advantageous in situations where a saliency point tends to move frequently and/or rapidly. However, other approaches to sending orientation information may be used, such as sending such information sporadically, as a cache, or in accordance with other protocols and/or criteria. When rendering the panoramic video content on the user's display, the pitch and yaw metadata can be used to find and/or alter the center point associated with the content. In some such example implementations, information about the rotation of the user's head is used in conjunction with the pitch and yaw metadata to redefine the center point and/or realign the video content. For example, if a user has rotated their head far to one side to view certain content, the center point can be shifted at a switch between video feeds or otherwise to allow the user to move their head back to a more comfortable position while continuing to focus on the image elements in which they may be most interested.

In some such example implementations, head rotation information used in conjunction with a pitch and yaw metadata stream can be used to automatically reorient the frame to allow the user to follow the movement of a particular image element as the element moves with respect to other image elements, without requiring a commensurate movement of the user's head. Some such example implementations, and others, may involve additional metadata streams, such as pitch and yaw information associated with multiple saliency points. For example, a viewer of a sporting event may choose to follow a particular player as the player moves throughout the field of play, regardless of the position of that player with respect to the ball, other players, or other salient information. Orientation information, such as pitch and yaw metadata associated with a camera's orientation with respect to the player, may be used in connection with the head position of the user, may be used to allow the viewer to follow the player and the player's movements without requiring large changes in the head position of the user.

In some example implementations directed toward causing a particular image element or point-of-interest to be rendered and/or otherwise displayed in or near a particular portion of a view presented to a viewer, position information associated with an image element or point-of-interest, such as absolute location and/or relative location information associated with a point of interest and/or other image element may be used to allow the user to follow the movement of the particular image element and/or point-of-interest as it moves with respect to other image elements, without requiring a commensurate movement of the user's head. For example, a viewer of a sporting event may choose to follow a particular player as the player moves throughout the field of play, regardless of the position of that player with respect to the ball, other players, or other salient information. Position information associated with the player may be used to allow the viewer to follow the player and the player's movements

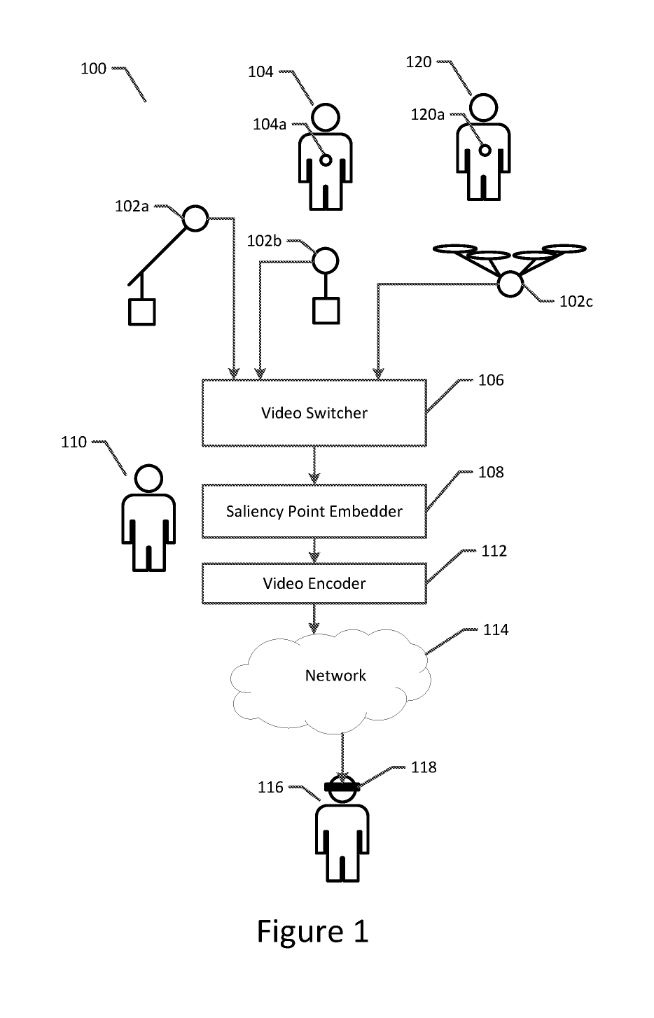

FIG. 1 an example system environment 100 in which implementations in accordance with an example embodiment of the present invention may be performed. The depiction of environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present invention. Rather, FIG. 1, and the environment 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

As shown in FIG. 1, system environment 100 includes cameras 102a, 102b, and 102c. Many implementations of system environment 100 contemplate the use of one or more cameras that are suitable for capturing 360° video images for use in the production of virtual reality content, such as Nokia's OZO system, and/or other cameras or camera arrays that can be used to create 360° video images and/or other panoramic views. In FIG. 100, cameras 102a, 102b, and 102c are shown as being mounted in a number of different example configurations, each allowing a different degree of freedom with respect to the movement of the camera with respect to image elements 104 and 120. For example, camera 102a is shown as being mounted on a moveable crane which may allow for the translation of the camera 102a by a limited distance in one, two, or three dimensions, and may permit the camera to engage in a degree of rotation about one or more axes. As shown in FIG. 1, camera 102b is mounted on a fixed stand, which may be particularly useful in setting the camera 102b in a single, fixed position and orientation with limited, if any, movement. FIG. 1 also shows camera 102c as being mounted to a remotely controllable drone, such as a vertical take-off and landing (VTOL) vehicle, which permits the camera 102c to move relatively large distances in any direction, and may also permit the camera to rotate about one or more axes.

As shown in FIG. 1, each of cameras 102a, 102b, and 102c are positioned in a manner that allows them to capture images that contain image element 104, and, optionally, in some circumstances, image element 120. While image element 104 (and image element 120) is drawn in a manner that implies that element 104 is a person, there is no requirement that image element 104 (or image element 120), be a human being, and any person, animal, plant, other organism, vehicle, artwork, animate or inanimate object, view, or other subject can be used in implementations of image element 104 and/or image element 120.

Some example implementations herein contemplate a saliency point as a point in an image, such as a point in a 360° image, that is considered to be the most salient point within the image to which attention should be directed. Some example implementations herein contemplate the presence within an image of one or more points-of-interest, which are considered to be image elements that may be of interest to one or more viewers. In many situations, the saliency point of an image will be a point-of-interest. Moreover, the saliency point of an image may change and/or be changed, such as being changed automatically by a system or system element and/or by an external actor such as a director. In some such situations, the saliency point may be switched from one point-of-interest to another.

FIG. 1 also shows image element 104 as having element point 104a. Element point 104a is, in some implementations, a point assigned to an image element to establish and/or mark a particular point associated with that image element, and may be used to establish a point of reference associated with element 104. Likewise, image element 120 is shown as having element point 120a, which may be used, for example, to establish a point of reference associated with element 120.

As shown in FIG. 1, each of cameras 102a, 102b, and 102c are capable of and/or configured to capture images, such as 360° video images, that may or may not contain depictions of image element 104, and transmit such images as a data stream. Such transmission can be accomplished in accordance with any approach and/or protocol that is suitable for transmitting image data from a camera to one or more devices. In some implementations, transmissions of image data are sent wirelessly or over a wired connection, in real time or near real time, to one or more devices configured to receive and/or process video images.

In addition to capturing images and transmitting a stream of image data, cameras 102a, 102b, and 102c are configured to determine their respective orientations with respect to element point 104a and transmit at least the pitch and yaw components of such orientation as a stream of metadata. As described herein, it may be particularly beneficial in some implementations for each camera to determine its orientation and transmit that orientation information in a manner that is synchronized with the camera's respective video image data on a frame-by-frame basis. In some such situations, synchronizing the orientation metadata stream to the camera's video image data stream on a frame-by-frame basis allows for the orientation of a camera point to be readily ascertained and updated on a frame-by-frame basis, as the camera is moved through a space and/or otherwise experiences a reorientation.

As shown in FIG. 1, cameras 102a, 102b, and 102c may transmit their respective video image streams and their respective, frame-by-frame synchronized orientation information metadata streams, to a video switcher 106. Video switcher 106 is representative of any of a class of devices that may be implemented as stand-alone devices and/or devices that may be integrated into other devices or components. As shown in FIG. 1, video switcher 106 is configured to receive the image data streams and the orientation information metadata streams from each of cameras 102a, 102b, and 102c, and, in some implementations, effect the selection of one or more of those image data streams (along with the corresponding orientation information metadata stream or streams) to a saliency point embedder, such as the saliency point embedder 108.

Like video switcher 106, saliency point embedder 108 is representative of any of a class of devices that may be implemented as stand-alone devices or devices that may be integrated into other devices or components. Also like video switcher 106, saliency point embedder 108 is configured to receive one or more image data streams (along with the corresponding orientation information metadata stream or streams). Saliency point embedder 108 is also configured to permit the selection and/or identification of one or more saliency points in a video stream and embedding that saliency point into the video stream. In some example implementations, saliency point embedder 108 may be configured to receive location information, such as location information associated with one or more image elements, for example, and embed such information. Director 110 is shown as an optional operator of saliency point embedder 108, and, in some implementations, is capable of monitoring one or more image data streams during the production and/or streaming of the image data streams, and causing a saliency point to be embedded into a particular location in a video stream, and/or overriding a previously identified saliency point. As noted above, the director 110 is optional in environment 100, and implementations of saliency point embedder 108 are possible where one or more saliency points are embedded in a video stream by saliency point embedder 108, the action of some other device, or otherwise without the presence of or action by a director or other entity.

As shown in FIG. 1, saliency point embedder 108 is configured to transmit one or more image data streams (along with the corresponding orientation information metadata stream or streams and/or any corresponding location information metadata stream or streams) to video encoder 112, which, like video switcher 106 and/or saliency point embedder 108 may be a stand-alone device, incorporated into another device, and/or distributed amongst multiple devices. In general, video encoder 112 is configured to, among other functions convert, transform, and/or otherwise prepare one or more image data streams (along with the corresponding orientation information metadata stream or streams) for transmission in a manner that will allow one or more viewing devices, such as virtual reality headset 118, to render the one or more image data streams into viewable content. As depicted in FIG. 1, video encoder 112 sends encoded 360° video with the related orientation information metadata over a network 114. Network 114 may be any network suitable for the transmission of 360° video and related orientation information metadata, directly and/or indirectly, from one or more devices, such as video encoder 112, to a viewing device, such as virtual reality headset 118. In some implementations, the network 114 includes and/or incorporates the public Internet.

FIG. 1 also depicts a user 116, who is associated with a viewing device, such as virtual reality headset 118. In general, virtual reality headset 118 is capable of receiving one or more data streams, such a one or more 360° image data streams (along with the corresponding orientation information metadata stream or streams), and rendering visible images that can be displayed to the user 116. In some implementations, virtual reality headset 118 is also capable of ascertaining positional information about the user 116, such as the angle and/or degree to which the user 116 has turned his or her head, and other information about the movement of the user 116's head. While FIG. 1 depicts user 116 as viewing content via a virtual reality headset 118, the user may view content via any viewing system that is configured to display all or part of the video transmitted to the user. For example, the user may use one or more monitors, mobile devices, and/or other handheld or desktop displays to view content.

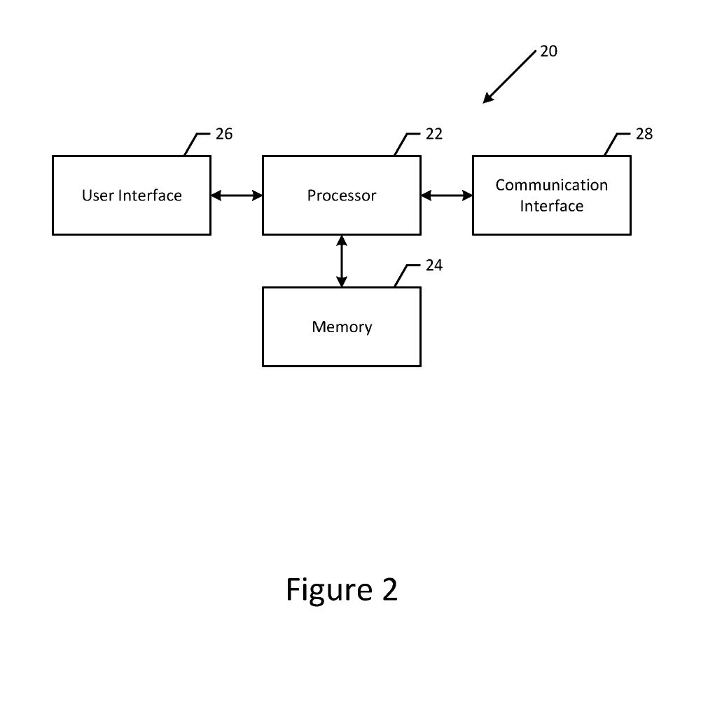

Based upon the orientation metadata, which, in many implementations, includes pitch and yaw measurements for a camera with respect to a given saliency point, the center point of an image, such as a 360° video image, can be ascertained and moved or otherwise altered. In this regard, the center point of an image may be generated, offset, or otherwise moved by an apparatus 20 as depicted in FIG. 2. The apparatus may be embodied by any of the cameras 102a, 102b, or 102c, or any of the other devices discussed with respect to FIG. 1, such as video switcher 106, saliency point embedder 108, video encoder 112, and/or devices that may be incorporated or otherwise associated with network 114. Alternatively, the apparatus 20 may be embodied by another computing device, external to such devices. For example, the apparatus may be embodied by a personal computer, a computer workstation, a server or the like, or by any of various mobile computing devices, such as a mobile terminal, e.g., a smartphone, a tablet computer, a video game player, etc. Alternatively, the apparatus may be embodied by a virtual reality system, such as a head mounted display such as virtual reality headset 118.

Regardless of the manner in which the apparatus 20 is embodied, the apparatus of an example embodiment is configured to include or otherwise be in communication with a processor 22 and a memory device 24 and optionally the user interface 26 and/or a communication interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 20 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 20 may optionally include a user interface 26 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

The apparatus 20 may optionally also include the communication interface 28. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

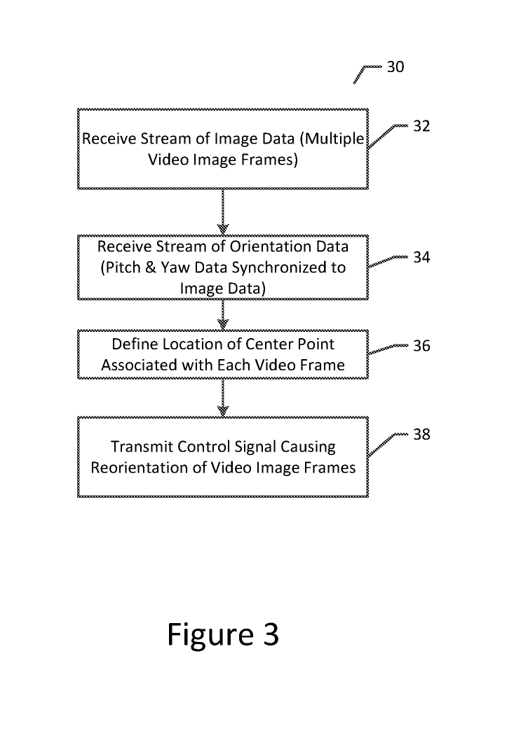

Referring now to FIG. 3, the operations performed by the apparatus 20 of FIG. 2 in accordance with an example embodiment of the present invention are depicted as an example process flow 30. In this regard, the apparatus includes means, such as the processor 22, the memory 24, the communication interface 28 or the like, for receiving image data, receiving orientation data that is synchronized with the image data, defining the location of a center point associate with each video image within the stream of image data, and determining whether to cause a control signal to be transmitted causing a reorientation of at least a subset of the plurality of video image frames, wherein the control signal is associated with the orientation data and the location of the center point. As such, the apparatus is generally capable of effecting the rotations and/or other reorientation of the video streams discussed and otherwise contemplated herein.

The apparatus includes means, such as the processor 22, the memory 24, the communication interface 28 or the like, for receiving image data, wherein the image data comprises a plurality of video image frames. For example, and with reference to block 32 of FIG. 3, the process 30 involves the receipt of a stream of image data, typically in the form of multiple video image frames. As discussed elsewhere herein, the stream of image data may originate with one or more cameras, such as the cameras 102a, 102b, and/or 102c discussed in connection with FIG. 1. In some example implementations, the video image frames within the plurality of video image frames are 360 degree video image frames, such as those captured and transmitted by cameras and/or camera arrays that are well-suited to the creation of virtual reality content and other immersive media, such as Nokia's OZO system. However, the image data need not be uniform, and may include image data for any type of image that can be mapped to a sphere and/or reoriented based at least in part on the movement and/or redefinition of a center point associated with the image.

The apparatus also includes means, such as the processor 22, the memory 24, the communication interface 28 or the like, for receiving orientation data, wherein the orientation data is synchronized with the image data and comprises a set of pitch and yaw information for each video image frame within the plurality of video image frames. As shown at block 34 in FIG. 3, process 30 involves receiving a stream of orientation information. While FIG. 3 depicts the receipt of such orientation information as a separate occurrence that is depicted as sequentially after the receipt if a stream of image data, neither process 30 nor any other aspect of FIG. 3 should be interpreted as imposing an order on the receipt of image data with respect to the receipt of orientation data. Moreover, and as discussed elsewhere herein, it is advantageous in many implementations and contexts for the orientation information to be synchronized to the image data on a frame-by-frame basis, such that orientation information associated with a particular image frame arrives simultaneously or nearly simultaneously with its associated image frame. In some example implementations, the pitch and yaw information for each video image frame within the plurality of video image frames is associated with an orientation of a camera associated with a saliency point within each video image frame. With reference to FIG. 1, the saliency point may be a saliency point associated with a particular image element, such as element point 104a, which is associated with image element 104 (and as element point 120a is associated with image element 120). However, any other saliency point that can be associated with an image may be used, including but not limited to a saliency point established by a director, viewer, or other third party, and/or a saliency point that is automatically established by the application of one or more saliency protocols.

The apparatus also includes means, such as the processor 22, the memory 24, the communication interface 28 or the like, for defining the location of a center point associated with each video image frame within the plurality of video image frames. As shown in block 36 in FIG. 3, for example, the apparatus, and other implementations of process 30, contemplate defining the center point for each frame of a video stream. In some example implementations, the center point associated with a particular video image frame may be dictated by the particular configuration of a camera, and/or initialized at a particular time.

However, some example implementations use the synchronized orientation information, such as pitch and yaw information, to ascertain the orientation of a camera associated with a saliency point and define the location of the center point accordingly. With reference to FIG. 1, three cameras, at least two of which can move non-trivially, are shown as being involved in capturing 360° video streams near image element 104. Some implementations of embodiments disclosed and contemplated herein use the orientation information to set the location of the center point of each video frame such that image element 104 appears in approximately the same relative position in each frame in the video stream for each camera, regardless of the movement and repositioning that may be done by one or more cameras. For example, if image element 104 is a performer on a stage, camera 102b may be configured such that the center point of the image is aligned with element point 104a in a manner places the performer directly “in front” as perceived by a viewer of the video stream received from camera 102b. In some implementations, the orientation information may be set by a director and/or set automatically via calculation by a computer vision algorithm. At the same time, camera 102a may be positioned via the movable crane to capture a profile view of the performer, and setting the center point such that the view of the performer is still generally centered in the frames captured by camera 102a. Moreover, because the orientation of camera 102a is transmitted as a metadata stream that is synchronized on a frame-by-frame basis with the video, the relative position of the performer can be maintained, regardless of the status of a movement of the crane and the related translation of the camera from one position to another. Likewise, camera 102c, which is mounted to a remotely controlled drone, can be used to capture images while being flown around the performer, while maintaining the depiction of the performer approximately in the center of the frame. Maintaining the position of a salient image element in the same or similar relative positions across video streams can be particularly beneficial in contexts where video content is transmitted to a viewer, particularly to a virtual reality headset, and wherein the content is presented in a manner that includes switching from one camera to another. In such situations, the salient image element (such as the performer) can be presented in a manner that is easy for the viewer to see, regardless of the orientation of the cameras capturing the underlying video.

It will be appreciated that the ability to define the location of the center point associated with each image need not be limited to ensuring that a particular element is always placed in the center of multiple camera feeds. Rather, the ability to ascertain the pitch and yaw of a camera associated with a saliency point on a frame-by-frame basis offers numerous advantages with regard to the ease and speed with which 360° images can be composed and oriented within the sphere experienced by a viewer, and may be particularly advantageous in the development of content used in live action virtual reality scenarios, where the ability to rapidly aim and position cameras, switch between camera feeds, account for unpredictable behavior by image elements, and/or maintain a cohesive viewing experience across switches between camera feeds may be highly desirable.

The apparatus also includes means, such as the processor 22, the memory 24, the communication interface 28 or the like, for determining whether to cause a control signal to be transmitted causing a reorientation of at least a subset of the plurality of video image frames, wherein the control signal is associated with the orientation data and the location of the center point. As shown in block 38 of FIG. 3, for example, as contemplated by at least some of the potential implementations of environment 100 in FIG. 1 and as discussed elsewhere herein, the ability to dynamically define and/or redefine the center point of an image affords a number of advantages to a user. In some example implementations of block 38 of FIG. 3, a control signal may take the form of a signal sent internally within a processor or other device that, when received can cause, either alone or in combination with other control signals and/or other operations, the reorientation of at least a subset of the plurality of video frames. In some implementations of block 38 of FIG. 3, the transmission of a control signal causing the reorientation of at least a subset of the plurality of video image frames involves sending a control signal, either directly by the apparatus or through any of the elements in environment 100, to a virtual reality headset, such as headset 118. In some such implementations, and as discussed elsewhere herein, transmitting such a control signal may be particularly advantageous in contexts where a user may be primarily interested in one or more image elements that are not rendered at or near the center of the rendered images, such that the user must maintain an uncomfortable or otherwise suboptimal head position to view their desired content. In some example implementations, causing a control signal to be transmitted causing a reorientation of at least a subset of the plurality of video image frames comprises causing a control signal associated with the center point to be transmitted to a plurality of cameras. In some implementations, transmitting the control signal to one or more cameras will trigger, in the camera, a reorientation of the image data transmitted by the camera to reflect the defined center point, a physical repositioning of the camera (such as through additional control signals that may cause a response by the mount affixed to a camera), or a combination of both.

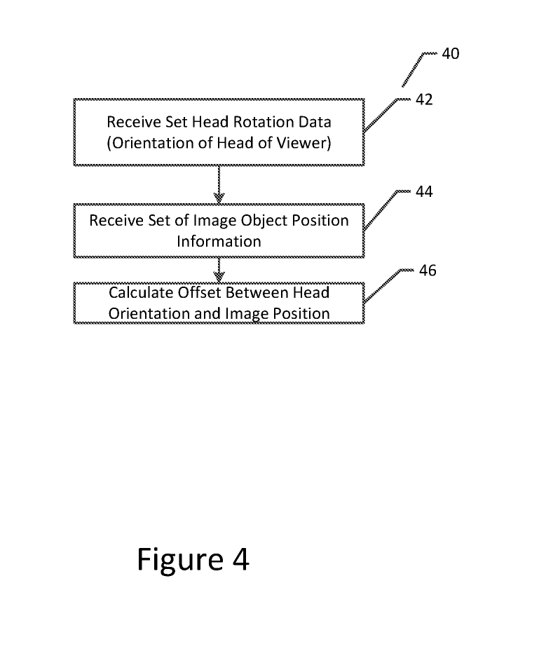

Referring now to FIG. 4, several additional, optional operations performed by the apparatus 20 of FIG. 2 in accordance with an example embodiment of the present invention are depicted as a process flow 40. In this regard, the apparatus includes means, such as the processor 22, the memory 24, the communication interface 28 or the like, for receiving a set of head rotation data, wherein the set of head rotation data is associated with an orientation of the head of a viewer of the image data; receiving a set of point-of-interest position information, wherein the set of point-of-interest position information comprises an indication of the location of an point-of-interest within a video image frame; and calculating an offset between the orientation of the head of the viewer of the image data and the location of the point-of-interest within each video image frame. As such, the apparatus is generally capable of performing several additional functions and/or operations involving the orientation of one or more images, the positioning of a viewer's head, the location of one or more points-of-interest within a video stream, and/or combinations of such functions and operations which may improve the experience of the viewer.

As discussed elsewhere herein, particularly with respect to FIG. 3, the apparatus includes means, such as the processor 22, the memory 24, the communication interface 28 or the like, for defining the location of a center point associated with each video image frame within the plurality of video image frames. In some example implementations, such as in the example contemplated by block 42 of FIG. 4, this comprises receiving a set of head rotation data, wherein the set of head rotation data is associated with an orientation of the head of a viewer of the image data. Some viewing devices, such as some virtual reality headsets, are configured with sensors and other components, circuitry, and/or software, to ascertain a user's head position, such as the degree to which the user has moved their head to the left or right with respect to their typical head orientation. As a result, it is possible in some implementations to ascertain whether a particular center point associated with content viewed by the viewer is resulting in, or would tend to result in, physical discomfort and/or an unpleasant viewing experience for the viewer. In some example implementations, the orientation metadata and or location metadata (either of which can establish the position of salient information with respect to a center point of an image, and in the case of location metadata, establish a relative and/or absolute position of one or more points of interest) and the head rotation information can be particularly useful, when combined, to determine and effect a reorientation of the viewed content to result in greater comfort to a viewer. For example, if the user is consistently looking far to the left in their viewer, at a camera switch or at another time, the center point of the rendered content can be redefined place the material that the user is viewing in or close to the center of the screen.

In some example implementations, and as shown in block 44 of FIG. 4, for example, the apparatus also includes means, such as the processor 22, the memory 24, the communication interface 28 or the like, for receiving a set of point-of-interest position information, wherein the set of point-of-interest position information comprises an indication of the location of a point-of-interest within a video image frame. In some situations, there may be multiple salient or otherwise interesting elements in a particular image. Likewise, one viewer of a stream of image data may consider certain image elements to be more interesting than a second viewer (or a director) would. For example, and with reference to FIG. 1, there are numerous contexts in which multiple image elements, such as image elements 104 and 120, are captured in the same image data stream or streams. One such example would be a sporting event, such as a football game, where multiple players are simultaneously present in the same general area, but may nonetheless be engaged in a broad range of activities across the field of play. In the context of a football game, a director, such as director 110 depicted in FIG. 1, may be generally tasked with ensuring one or more video feeds focus on the ball and/or the most active events on the field. In contrast, however a particular viewer may have a favorite player, and may be interested in a viewing experience that allows the viewer to view all of the movements of their favorite player by virtually following that player throughout the event, regardless of whether the favorite player was in possession of or near the ball or other action. Similarly in the context of a concert or a stage play, a viewer may be interested in a viewing experience where they focus on a particular performer, regardless of the actions of other participants on stage.

Some approaches to providing a viewing experience that allows the viewer to follow a particular image element regardless of how other viewers or content producers may assess the saliency of that element at a given time contemplate the use of multiple orientation metadata streams, and/or calculating an offset between the orientation of the head of the viewer and a particular point-of-interest within a video image frame. In at least these regards, the apparatus also includes means, such as the processor 22, the memory 24, the communication interface 28 or the like, for defining the location of a center point associated with each video image frame within the plurality of video image frames by calculating an offset between the orientation of the head of the viewer of the stream of image data and the location of the point-of-interest within each video image frame. For example, and with reference to block 46 of FIG. 4, and FIG. 1, a user may be primarily interested in viewing image element 120, but, upon beginning to view virtual reality content featuring elements 104 and 120, element 104 is generally positioned in the center of the frame and/or is used by a content producer to set the center point of the content transmitted to the virtual reality headset. If the user prefers to view element 120, the head rotation data may show that the user's head is consistently not aligned with the center of the field of view. This offset between the original center point and the user's head position can be calculated, and used as part of a process to trigger a prompt to the user to switch the center point to focus on element 120, or may be used to automatically redefine the center point of the image to focus on element 120. The frame-by-frame synchronization of the orientation of a camera with respect to multiple elements within a given frame and/or the frame-by-frame synchronization of location data associated with one or more image elements may be particularly advantageous in such situations. For example, in situations where the orientation of a camera with respect to element point 104a and element point 120a and/or the location of element point 104a and/or element point 120a was synchronized with the image data stream for each camera, establishing a saliency point or other point-of-interest as the center point and/or switching between saliency points and/or points-of-interest can be readily accomplished. Moreover, in situations where multiple sets of synchronized orientation metadata and/or location metadata is transmitted to a user's viewing device along with a video stream, the user may be able to exert a large degree of control over the center point of the content rendered in their own viewing device by tying the center point to a particular saliency point, switching amongst saliency points, and/or applying other protocols regarding how the center point should be defined with respect to one or more saliency points. While some of the example implementations described herein focus on the use of head position information in the context of a virtual reality headset, other implementations are possible. For example, and as discussed with respect to FIG. 1, a viewer may use any of a range of devices and combinations of devices to view content, including but not limited to one or more monitors, mobile devices and/or other handheld or desktop displays. Consequently, in some example embodiments, information about a user's preferences regarding points-of-interest and/or other image elements to involve in the reorientation of image may be obtained from inputs made by the user, such as through one or more user interfaces, and/or otherwise determined, such as through the use of other devices to determine the position and/or orientation of a viewer with respect to the content displayed to the user.

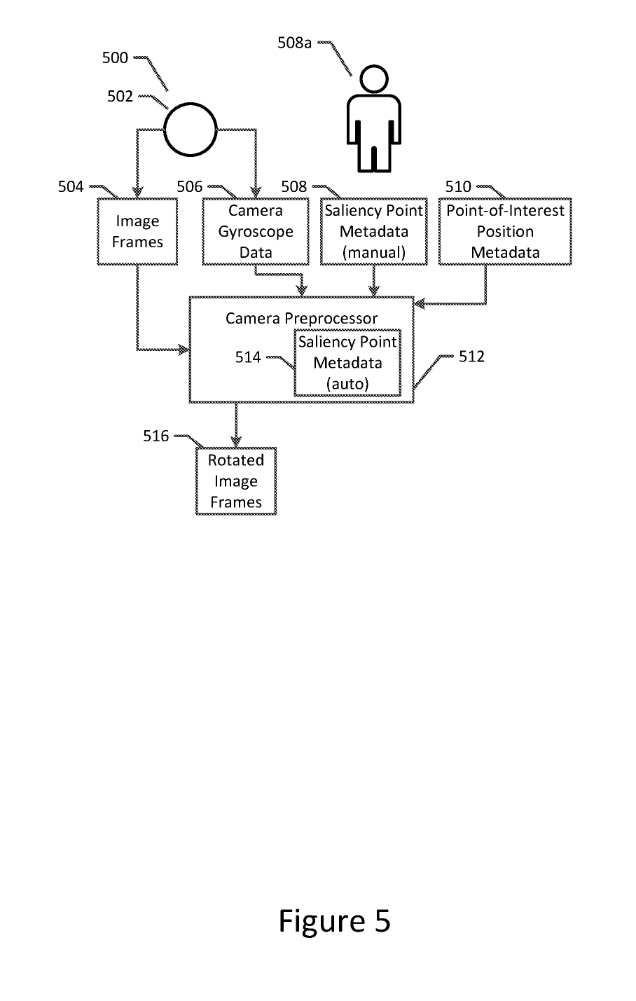

FIG. 5 depicts an example system environment 500 in which implementations in accordance with an example embodiment of the present invention may be performed. In example system environment 500, image rotation and/or switching is performed prior to the transmission of images to one or more viewers. As shown in FIG. 5, system environment 500 includes at least one camera 502. In many example implementations, camera 502 is a camera configured to capture 360° images, such as 360° video images. However, any of the cameras referenced and/or contemplated herein may be used in implementations of camera 502. In system environment 500, camera 502 is capable of transmitting one or more image frames 504 to camera preprocessor 512. As shown, camera preprocessor 512 may be configured as a stand-alone device (as depicted), as a combination of any of a number of devices, and/or integrated into one or more other devices. Regardless of the particular configuration of camera preprocessor 512, camera preprocessor 512 is generally capable of receiving image frames from one or more cameras, such as camera 502, and any of a number of sources of metadata that can be associated with an image frame. As shown in FIG. 5, camera preprocessor 512 is configured to receive camera gyroscope data 506, saliency point metadata 508 that may, in some situations, be manually set (such as by a director 508a), point-of-interest position metadata 510, saliency point metadata 514, which may be automatically generated, such as through the operation of an algorithm or other automated protocol. In some example implementations, one or more types of metadata may be synchronized to the image frame 504, including but not limited to being synchronized on a frame-by-frame basis. In some example implementations, one or more types of metadata may be sent in accordance with other protocols, such as periodic transmissions, transmission triggered by a change in the data, and/or any other protocol.

While several types of metadata are depicted as being provided to camera preprocessor 512, it will be understood that more, fewer, and/or other types of metadata may be provided to camera preprocessor 512, depending on the particulars of the specific implementation. Moreover, while the automated saliency point metadata 514 is shown as originating within the camera it may be generated external to camera preprocessor 512 and otherwise communicated to camera preprocessor 512.

Based at least in part on the metadata received, camera preprocessor 512 is capable of rotating the image frames 504. In some example implementations, a director may choose and/or use information received from the metadata sources available to camera preprocessor 512, and determine the rotation that should be applied to an output of image frames from the camera preprocessor 512. In some example implementations, a rotation may be applied without the interaction of a director, such as through the application of automated programs and/or protocols that automatically rotate the output of camera preprocessor 512 based at least in part on the metadata received by camera preprocessor 512. As shown in FIG. 5, camera preprocessor 512 generates an output of rotated image frames, depicted as the rotated image frames 516.

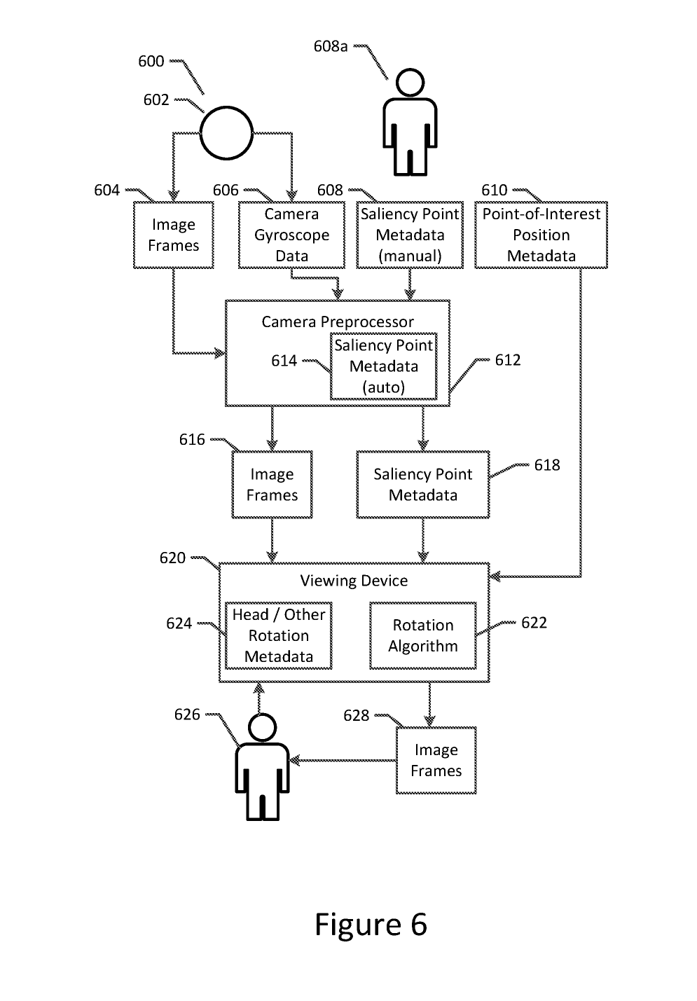

FIG. 6 depicts an example system environment 600 in which implementations in accordance with an example embodiment of the present invention may be performed. In example system environment 600, image rotation and/or switching is performed by a viewing device, such as viewing device 620, and takes into account information associated with a viewer. Like system environment 500 shown in FIG. 5, system environment 600 includes at least one camera 602, which is configured to send image frames 604 to a camera preprocessor 612. As also shown in FIG. 6, camera preprocessor 612 is also configured to receive metadata in the form of one or more of camera gyroscope data 606, manual saliency point metadata 608, point-of-interest position metadata 610, and automated saliency point metadata 614. It will be appreciated that the camera 602, the camera preprocessor 612, and the sources of metadata (such as camera gyroscope data 606, manual saliency point metadata 608, director 608a, point-of-interest position metadata 610, and automated saliency point metadata 614 correspond to and are analogous to their respective counterparts in FIG. 5, and any approach to implementations of the system environment 500 in FIG. 5, including but not limited to elements therein, may be used in implementations of the system environment 600, including but not limited to elements therein.

As shown in FIG. 6, camera preprocessor 612 is also configured to transmit image frames 616, which may or may not be rotated with respect to image frames 604, and saliency point metadata 618, to a viewing device 620. In some example implementations, the image frames 616 and the saliency point metadata 618 are synchronized streams of information, and may be synchronized, in some implementations, on a frame-by-frame basis.

Viewing device 620 may be implemented as any of the viewing devices described or otherwise contemplated herein, including but not limited to a virtual reality headset, and/or one or more monitors, is configured to receive the image frames 616 and the saliency point metadata 618. In some example implementations, and as shown in FIG. 6, viewing device 620 is also configured to receive point-of-interest position metadata 610 (either directly and/or indirectly, such as via the saliency point metadata 618 or otherwise from camera preprocessor 612) as well as rotation metadata 624, which includes information regarding the head rotation and/or other rotation or position information of a viewer 626.

Viewing device 620 also is configured to apply rotation algorithm 622, which, in some example implementations determines a rotation and/or other reorientation of an image frame based in least in part on the rotation metadata 624, saliency point metadata 618, point-of-interest position metadata 610, and/or any combination thereof. Once a rotation and/or reorientation of an image frame is determined, rotated image frames, such as rotated image frames 628, can be presented to the viewer 626. It will be appreciated that example implementations of system environment 500 and/or system environment 600 may be used in connection with example implementations of any of the processes, methods, and/or other approaches to the reorientation, switch, rotation, and/or other processing of one or more images described and/or contemplated herein.

As described above, FIGS. 3 and 4 illustrate flowcharts of an apparatus 20, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving image data, wherein the image data comprises a plurality of video image frames;
receiving orientation data, wherein the orientation data is synchronized with the image data and comprises a set of pitch and yaw information for each video image frame within the plurality of video image frames;
defining the location of a center point associated with each video image frame within the plurality of video image frames; and
determining whether to cause a control signal to be transmitted causing a reorientation of at least a subset of the plurality of video image frames, wherein the control signal is associated with the orientation data and the location of the center point.

2. A method according to claim 1, wherein the video image frames within the plurality of video image frames are 360 degree video image frames.

3. A method according to claim 2, wherein the pitch and yaw information for each video image frame within the plurality of video image frames is associated with an orientation of a camera.

4. A method according to claim 3, wherein determining whether to cause a control signal to be transmitted causing a reorientation of at least a subset of the plurality of video image frames comprises causing a control signal associated with the center point to be transmitted to a plurality of cameras.

5. A method according to claim 1, wherein defining the location of a center point associated with each video image frame within the plurality of video image frames comprises receiving a set of head rotation data, wherein the set of head rotation data is associated with an orientation of the head of a viewer of the image data.

6. A method according to claim 5, further comprising receiving a set of point-of-interest position information, wherein the set of point-of-interest position information comprises an indication of the location of a point-of-interest within a video image frame.

7. A method according to claim 6, wherein defining the location of a center point associated with each video image frame within the plurality of video image frames comprises calculating an offset between the orientation of the head of the viewer of the image data and the location of the point-of-interest within each video image frame.

8. An apparatus comprising at least one processor and at least one memory storing computer program code, the at least one memory and the computer program code configured to, with the processor, cause the apparatus to at least:
receive image data, wherein the image data comprises a plurality of video image frames;
receive orientation data, wherein the orientation data is synchronized with the image data and comprises a set of pitch and yaw information for each video image frame within the plurality of video image frames;
define the location of a center point associated with each video image frame within the plurality of video image frames; and
determine whether to cause a control signal to be transmitted causing a reorientation of at least a subset of the plurality of video image frames, wherein the control signal is associated with the orientation data and the location of the center point.

9. An apparatus according to claim 8, wherein the video image frames within the plurality of video image frames are 360 degree video image frames.

10. An apparatus according to claim 9, wherein the pitch and yaw information for each video image frame within the plurality of video image frames is associated with an orientation of a camera.

11. An apparatus according to claim 10, wherein the at least one memory and the computer program code are configured to, with the processor, cause the apparatus to determine whether to cause the control signal to be transmitted causing the reorientation of at least a subset of the plurality of video image frames by causing the apparatus to cause a control signal associated with the center point to be transmitted to a plurality of cameras.

12. An apparatus according to claim 8, wherein the at least one memory and the computer program code are configured to, with the processor, cause the apparatus to define the location of the center point associated with each video image frame within the plurality of video image frames by causing the apparatus to receive a set of head rotation data, wherein the set of head rotation data is associated with an orientation of the head of a viewer of the image data.

13. An apparatus according to claim 12, wherein the at least one memory and the computer program code are configured to, with the processor, further cause the apparatus to receive a set of point-of-interest position information, wherein the set of point-of-interest position information comprises an indication of the location of a point-of-interest within a video image frame.

14. An apparatus according to claim 13, wherein the at least one memory and the computer program code are configured to, with the processor, cause the apparatus to define the location of the center point associated with each video image frame within the plurality of video image frames by causing the apparatus to calculate an offset between the orientation of the head of the viewer of the image data and the location of the point-of-interest within each video image frame.

15. A computer program product comprising at least one non-transitory computer-readable storage medium having computer-executable program code instruction stored therein, the computer-executable program code instructions comprising program code instructions configured to:
receive image data, wherein the image data comprises a plurality of video image frames;
receive orientation data, wherein the orientation data is synchronized with the image data and comprises a set of pitch and yaw information for each video image frame within the plurality of video image frames;
define the location of a center point associated with each video image frame within the plurality of video image frames; and
determine whether to cause a control signal to be transmitted causing a reorientation of at least a subset of the plurality of video image frames, wherein the control signal is associated with the orientation data and the location of the center point.

16. A computer program product according to claim 15, wherein the video image frames within the plurality of video image frames are 360 degree video image frames.

17. A computer program product according to claim 16, wherein the pitch and yaw information for each video image frame within the plurality of video image frames is associated with an orientation of a camera.

18. A computer program product according to claim 15, wherein the computer-executable program code instructions further comprise program code instructions configured to:
determining whether to cause the control signal to be transmitted causing the reorientation of at least a subset of the plurality of video image frames by causing a control signal associated with the center point to be transmitted to a plurality of cameras.

19. A computer program product according to claim 15, wherein the computer-executable program code instructions further comprise program code instructions configured to define the location of the center point associated with each video image frame within the plurality of video image frames by receiving a set of head rotation data, wherein the set of head rotation data is associated with an orientation of the head of a viewer of the image data.

20. A computer program product according to claim 19, wherein the computer-executable program code instructions further comprise program code instructions configured to:
receive a set of point-of-interest position information, wherein the set of point-of-interest position information comprises an indication of the location of a point-of-interest within a video image frame; and
define the location of the center point associated with each video image frame within the plurality of video image frames by calculating an offset between the orientation of the head of the viewer of the image data and the location of the point-of-interest within each video image frame.
